(19) United States
(12) Patent Application Publication
(10) Pub. No.: US 2026/0016056 A1
(43) Pub. Date: Jan. 15, 2026

(54) MULTIFUNCTIONAL SHAFT ADAPTER, LOCKING DEVICE, ELECTRIC MOTOR DRIVE UNIT, AND VEHICLE

(71) Applicant: Schaeffler Technologies AG & Co. KG, Herzogenaurach (DE)

(72) Inventors: Karl Martin FRITSCH, Battenberg (DE); Jens HENRICH, Schmitten (DE); Jan WEIMAR, Hofheim (DE); Philip KIEPER, Königstein (DE)

(21) Appl. No.: 18/993,766

(22) PCT Filed: Jul. 10, 2023
(86) PCT No.: PCT/EP2023/069082

§ 371 Date: Jan. 13, 2025

(30) Foreign Application Priority Data
Jul. 15, 2022 (DE) 10 2022 207 255.3

(51) Int. Cl. F16D 63/00; F16D 121/24; F16D 125/40; H02K 7/06

(52) U.S. Cl. CPC F16D 63/006; H02K 7/06; F16D 2121/24; F16D 2125/40

(57) ABSTRACT

A multifunctional shaft adapter for a locking device provided for fitting to an electric motor drive unit. The shaft adapter can be connected to a lockable shaft of the electric motor drive unit and is substantially produced from a plastics material into which are embedded contacting elements for external excitation of a rotor of a synchronous machine of the electric motor drive unit, the rotor being connected to the shaft, and which is additionally materially connected to a positive-locking element for connection to the shaft. A locking device has such a multifunctional shaft adapter.

### CROSS REFERENCE TO RELATED APPLICATIONS

This is a U.S. national stage of Application No. PCT/EP2023/069082 filed Jul. 10, 2023. Priority is claimed on German Application No. DE 10 2022 207 255.3 filed Jul. 15, 2022, the contents of which are incorporated herein by reference.

### BACKGROUND OF THE INVENTION

### 1. Field of the Invention

The disclosure relates to a multifunctional shaft adapter for a locking device, to a locking device having such a multifunctional shaft adapter, to an electric motor drive unit having such a locking device, and to a vehicle having such an electric motor drive unit.

### 2. Description of the Related Art

The locking device proposed in the context of this disclosure represents a further development of the locking devices described in the German patent applications with the file references 10 2021 213 737.7 and 10 2021 213 739.3.

### SUMMARY OF THE INVENTION

An object of one aspect of the invention is to provide an improved locking device, in particular for a vehicle.

This object is achieved by a multifunctional shaft adapter.

A multifunctional shaft adapter for a locking device is proposed, which is provided for fitting to an electric motor drive unit.

In this instance, the shaft adapter can be connected to a lockable shaft of the electric motor drive unit and, in this instance, is substantially produced from a plastics material into which are embedded contacts for external excitation of a rotor of a synchronous machine of the electric motor drive unit, said rotor being connected to the shaft, and which is additionally materially connected to a positive-locking element for connection to the shaft.

On the one hand, the proposed shaft adapter allows a blocking or locking function of the locking device since it is part of the locking mechanism of the locking device and, on the other hand, allows said external excitation of the synchronous machine.

In one aspect of the invention, the contacts comprise at least two slip rings for contacting with an associated brush, and at least one conductor track, which is associated with the respective slip ring and which extends from the associated slip ring through the plastics material of the shaft adapter.

In another aspect of the invention, a sensor component of metallic design, at least in some portion or portions, for interaction with a signal transmitter, fixed relative to a housing of the locking device, for position detection of the rotor of the synchronous machine is received in a fixed location by the shaft adapter. The proposed shaft adapter thus also enables said position detection of the rotor of the synchronous machine.

A locking device for an electric motor drive unit is furthermore proposed. The locking device has in this instance a locking mechanism for locking a lockable shaft of the electric motor drive unit, and an electric drive for actuating the locking mechanism, which in addition to the locking mechanism is received by a housing of the locking device.

In this instance, the housing of the locking device furthermore receives a multifunctional shaft adapter of the type described above, with respect to the positive- locking element of which a further positive-locking element of the locking mechanism can be actuated in an axial stroke movement and longitudinally with respect to the shaft to lock the shaft.

Such a locking device advantageously contributes to the reduction of components and thus installation space. Consequently, assembly complexity can also advantageously be simplified.

The locking mechanism comprises in this instance a positive-locking element which can be actuated in an axial stroke movement and longitudinally with respect to the shaft and which can be joined to a shaft-side complement within a positive-locking region in a positive-locking manner, at least in some portion or portions, in order to lock the shaft.

In this instance, this actuatable positive-locking element can, in a state bearing at the end face on the shaft-side complement, be engaged, preloaded or braced longitudinally with respect to the shaft by at least one elastic force transmission element in a defined manner with respect to the shaft-side complement.

In a locking state of the shaft, in which the actuatable positive-locking element and the shaft-side complement engage in each other in the positive-locking region of the locking mechanism, the actuatable positive-locking element is in this instance supported against a housing portion of an electric motor drive unit, to which housing portion the locking actuator is fitted.

In the positive-locking region and in the circumferential direction of the shaft, the locking mechanism in this instance has movement play between the actuatable positive-locking element and the shaft-side complement, which play, together with said or above-mentioned preloading/bracing of the actuatable positive-locking element with respect to the shaft-side complement, enables engagement of the actuatable positive-locking element in the shaft-side complement or joining of the actuatable positive-locking element to the shaft-side complement.

A shaft-side complement is in this instance intended to be understood to be a shaft-side counterpart to the actuatable positive-locking element, which counterpart is designed or shaped in the positive-locking region in a correspondingly complementary manner to the actuatable positive-locking element. In this instance, it may be a correspondingly shaped portion of the shaft itself or a separate and correspondingly shaped element which is joined to the shaft and which cooperates in a positive-locking manner with the actuatable positive-locking element.

An elastic force transmission element is in this instance intended to be understood to be a mechanical energy store for elastic preloading/bracing of the actuatable positive-locking element with respect to the shaft-side complement, for instance in the form of at least one separate spring or a separate spring element and/or in the form of at least one spring element portion integrated into the actuatable positive-locking element.

This energy store preloads the actuatable positive-locking element with respect to the shaft-side complement until the shaft assumes or undergoes a suitable orientation for positive locking relative to the actuatable positive-locking element. As soon as such an orientation is present, this energy store presses the actuatable positive-locking element for engagement in the shaft-side complement so that the shaft is locked or blocked.

In addition, the locking mechanism can be actuated in an energy-saving manner since it does not require high actuation forces to be applied either for said actuation or for said preloading/bracing. This is because, during the joining of the actuatable positive-locking element to the shaft-side complement, only the actuatable positive-locking element and not also the drive-train element to be blocked is moved.

In one embodiment, the electric drive is arranged transversely relative to the shaft. Such a transverse arrangement advantageously provides installation space for reception of said contacting elements by the housing of the locking device.

In this instance, the term “transverse” is intended to be understood to be either an orthogonal arrangement of the electric drive with respect to the shaft or, alternatively, an arrangement in which a longitudinal axis of the electric drive forms an acute or obtuse angle with a longitudinal axis of the lockable shaft.

In this instance, at least two brushes for said external excitation of the rotor, which is connected to the shaft, of the synchronous machine of the electric motor drive unit are additionally received by the housing of the locking device.

In another aspect of the invention, the brushes are arranged radially with respect to the shaft. Such a radial arrangement also promotes a compact configuration of the locking device.

In this instance, it is proposed to place or to contact the brushes in a spring-loaded manner against an associated slip ring of the contacting element. Readjustment of brushes which become worn over time with respect to the associated slip rings is thereby ensured.

There is further proposed an electric motor drive unit, in particular for driving a vehicle having a locking device of the above-described type, which is fitted to a housing of the electric motor of the electric motor drive unit.

In addition, a vehicle having an electric motor drive unit of the above-described type is proposed.

A vehicle is intended in this instance to be understood to be any type of vehicle or motor vehicle which is driven by electric motor, but in particular passenger motor vehicles and/or commercial vehicles. These are preferably partially autonomously and in particular fully autonomously operated vehicles.

### BRIEF DESCRIPTION OF THE DRAWINGS

The invention is explained in detail below with reference to the illustrations of the figures. Other advantageous further developments of the invention can be derived from the dependent claims and the following description of preferred embodiments. In the drawings:

FIG. 1A is a perspective view of an electric motor drive unit having a proposed locking device;

FIG. 1B is a perspective and enlarged view of a portion of the locking device;

FIG. 2 is the locking device shown in FIG. 1A as a planar sectioned view;

FIG. 3 is a locking mechanism of the locking device with an arrangement of contacting elements;

FIG. 4 is the arrangement, shown in FIG. 3, of the locking mechanism and the contacting elements as a perspective view;

FIG. 5 is a multifunctional shaft adapter of the locking device;

FIG. 6 is a positive-locking region between a lockable shaft and the locking device as a sectioned view;

FIG. 7 is a perspective and enlarged view of the positive-locking region shown in FIG. 6; and

FIG. 8 is a perspective sectioned view of the locking device.

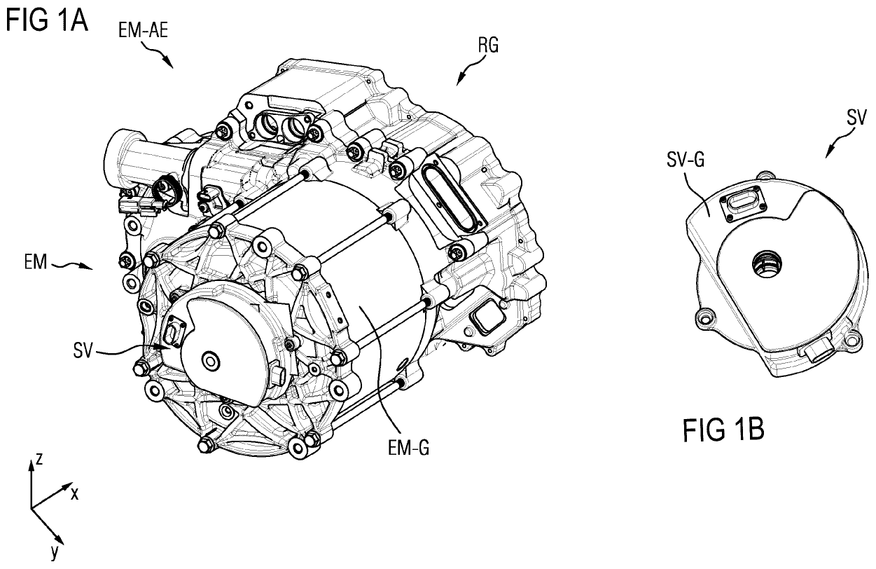

### DETAILED DESCRIPTION OF THE PRESENTLY PREFERRED EMBODIMENTS

The proposed locking device SV is fitted to an electric motor drive unit EM-AE, in particular for driving a vehicle. The electric motor drive unit EM-AE comprises in this instance an electric motor EM in the form of an externally excited synchronous machine and a reduction gear mechanism RG which is connected thereto. The locking device SV is in this instance arranged on a housing EM-G of the synchronous machine.

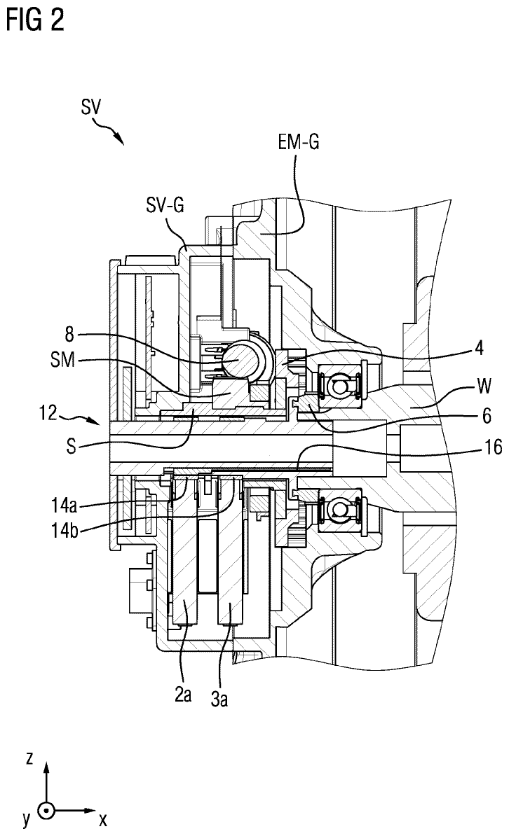

The locking device SV has a locking mechanism and an electric drive EA for actuating the locking mechanism, which is received in addition to the drive EA by a housing SV-G of the locking device. For example, FIG. 2 illustrates in this instance very clearly that a housing portion EM-G of the synchronous machine forms part of the housing SV-G of the locking device.

The drive EA is in this instance arranged transversely—and orthogonally—with respect to the shaft W or shaft axis X-X. In an embodiment which is not illustrated here, the drive EA may also be arranged with respect to the shaft in such a manner that a longitudinal axis of the drive EA forms an acute or obtuse angle with the longitudinal axis X-X of the shaft W.

The drive EA in this instance drives a helical gear shaft 8, which in turn cooperates with a gear segment 10 of a spindle nut SM with an inner thread. This spindle nut SM is in this instance joined in a longitudinally displaceable manner to a spindle S having a corresponding outer thread which together with the spindle nut SM forms a so-called screw drive or a so-called helical gear transmission which converts a rotational movement of the spindle nut SM (anti-clockwise or clockwise) into a translation movement of the spindle nut SM along the spindle S and in the longitudinal direction X-X or along the shaft W. The spindle S is in this instance arranged to be fixed with respect to the housing SV-G and is supported with respect to the housing SV-G (FIG. 2).

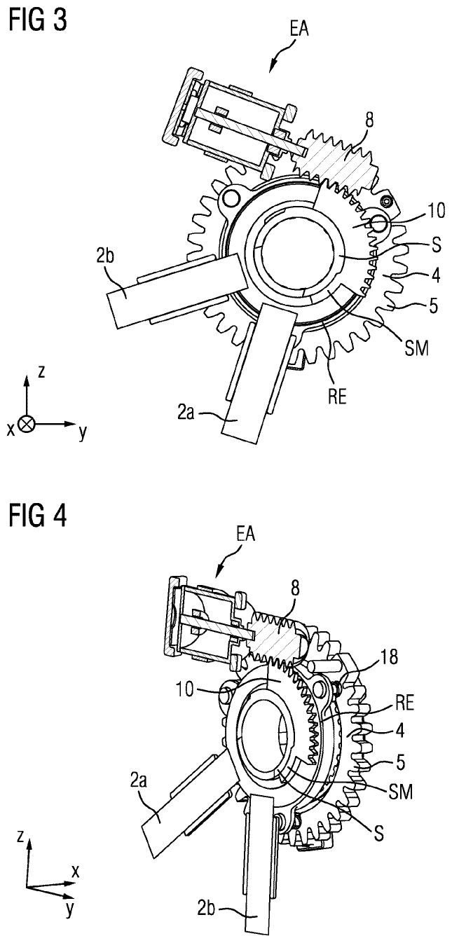

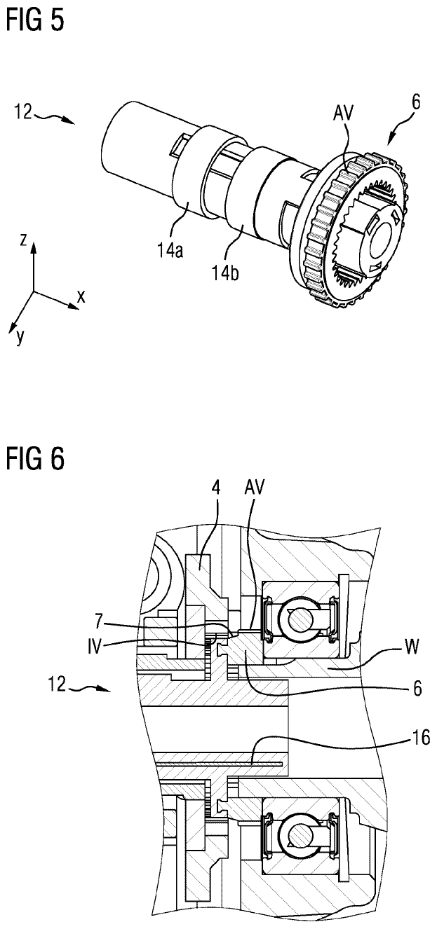

On the shaft side, the spindle nut SM is elastically preloaded (FIG. 3, FIG. 4) via a ring element RE, which is mounted in a low-friction manner, via a rolling bearing, on the spindle nut SM itself, and individual springs, for instance in the form of helical springs 18, with respect to a positive-locking element 4 which can be actuated in the longitudinal direction X-X or along the shaft W.

This positive-locking element 4 is thus elastically connected, via these—for instance, three—helical springs 18 arranged in a manner distributed over the circumference of the ring element RE, to a movement mechanism of the locking device SV, which brings about the axial stroke movement of the positive-locking element 4.

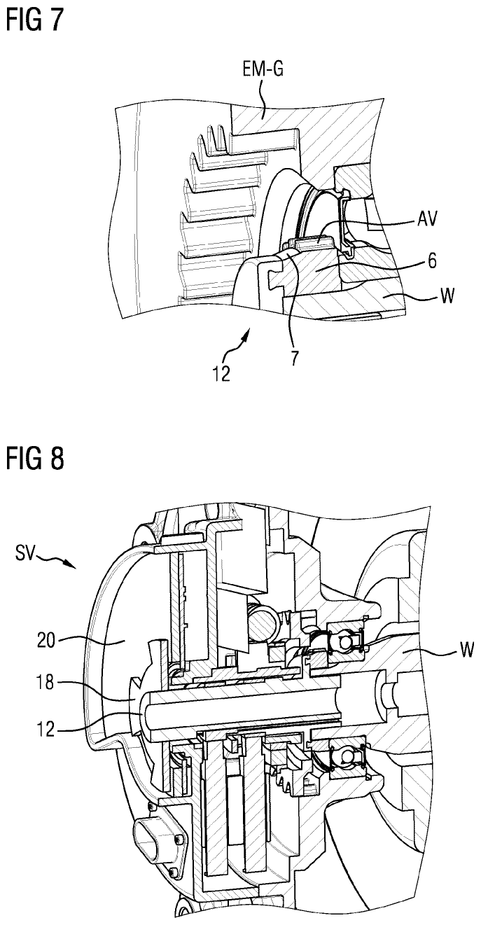

This positive-locking element 4 is in this instance made from metal and of high-strength design and is in the form of a closed encircling, annular element having an inner tooth arrangement IV and an outer tooth arrangement 5. Whilst the inner tooth arrangement IV can be moved into an outer tooth arrangement AV of a shaft-side and metallically high-strength complement 6 in order to lock the shaft W in a positive-locking manner, the outer tooth arrangement 5 cooperates continuously with a complementarily configured portion of the electric motor housing EM-G in a positive-locking manner. This positive-locking connection ensures guidance and support of the positive-locking element 4 with respect to the electric motor housing EM-G. In this instance, this outer tooth arrangement 5 enables advantageous or uniform force distribution over the circumference of the positive-locking element 4 and at the same time favorable or uniform introduction of force into the electric motor housing EM-G. FIG. 7 illustrates in this instance the portion which is formed on the electric motor housing EM-G so as to complement the outer tooth arrangement 5, with the inner tooth arrangement thereof. In this instance, the positive-locking element 4 is not illustrated or is hidden or omitted for the sake of simplicity.

Thus, in the locking state of the shaft W, both static and dynamic torque loads of the drive train are introduced via this outer tooth arrangement 5 into the electric motor housing EM-G.

Alternatively to the outer tooth arrangement 5, an outer profiling of the positive-locking element 4 may also be provided in the form of individual, radial claw-like projections. In this regard, reference may be made to the German patent applications which have already been mentioned in the introduction with the file references 10 2021 213 737.7 and 10 2021 213 739.3 which describe and illustrate this.

The locking device SV further has a multifunctional shaft adapter 12, which extends through the spindle S and into a region of the hollow shaft W. This shaft adapter 12 is in this instance substantially produced from a plastics material in which two metal slip rings 14a, 14b and a metal conductor track or contact path 16, which is associated with the respective slip ring 14a, 14b, are embedded. The conductor track 16 extends in this instance from the associated slip ring 14a, 14b in the direction of the hollow shaft W through the plastics material of the shaft adapter 12.

Furthermore, the plastics material of the shaft adapter 12 is injection-moulded or materially connected to the shaft-side complement 6, which is in the form of a metal adapter ring. FIG. 6 illustrates in this instance, by way of example, an annular projection of the adapter ring or positive-locking element 6, which is formed at the end face on the adapter ring 6 and facing the positive-locking element 4 in the form of a dovetail and is enclosed by a plastics material flange of the shaft adapter 12. This adapter ring 6 has in this instance an outer tooth arrangement AV which complements the inner tooth arrangement IV and in addition an inner profiling or inner tooth arrangement, via which the adapter ring 6 and consequently the shaft adapter 12 is pressed onto a correspondingly complementarily formed outer profiling or outer tooth arrangement of the hollow shaft W.

Via the adapter ring 6, the proposed locking device SV can advantageously be adapted to different shaft diameters.

In a state arranged radially with respect to the shaft adapter 12, two brushes 2a, 2b, 3a, 3b are in each case associated with the two slip rings 14a, 14b and in this instance received by the housing SV-G. The brushes 2a, 2b, 3a, 3b are in this instance applied or contacted in a spring-loaded manner to the associated slip rings 14a, 14b. In this instance, the brushes 2a, 2b, 3a, 3b which are associated with a slip ring 14a, 14b and which form a pair are arranged in such a manner with respect to each other that they enclose an angle at the same height (FIG. 3, FIG. 4).

For the purposes of orientation of the two positive-locking elements 4, 6 with respect to each other, there is formed on the positive-locking element 6 at the end face and facing the positive-locking element 4 a tapering portion 7 which acts in a centering manner (FIG. 6, FIG. 7). In the case of an axial offset between the positive-locking element 4 and the positive-locking element 6 or the hollow shaft W, the inner tooth arrangement IV may, during a longitudinal displacement of the positive-locking element 4 in the direction X-X, strike against this tapering portion or centering portion 7 in order to be aligned with respect to the outer tooth arrangement AV and consequently the hollow shaft W. In addition to a locking function, the positive-locking element 6 consequently also has a centering function, which ensures coaxial alignment of the two positive-locking elements 4, 6 with respect to each other. Uniform force distribution over the circumference of the two positive-locking elements 4, 6 is thereby ensured in the joined state.

The locking device SV further comprises a, for example, inductively acting position sensor arrangement for detecting a position of the rotor, which is connected to the shaft W, of the synchronous machine in order to enable efficient electronic commutation of the synchronous machine. FIG. 8 illustrates in this instance, by way of example, a position sensor arrangement in the region of the outer end of the shaft adapter 12 or of the end of the shaft adapter 12 which faces away from the shaft end.

In this instance, there is provided a signal transmitter which is fixed with respect to the housing SV-G and which is integrated into a circuit board 20 and which has a coil arrangement which cooperates with a sensor component which is fixed in position with respect to the hollow shaft W and is in the form of a metal, disk-like element 18. This element 18, which is arranged opposite the circuit board, is in this instance received by the plastics material of the shaft adapter 12 and in a fixed location with respect to the shaft adapter 12. In this instance, this element 18 has at the circumference individual radial, claw-like projections which as such bring about detuning of a magnetic field acting on them. At least these radial, claw-like projections may in this instance be of magnetic, for example, ferromagnetic design. In a simple exemplary embodiment, this disk-like element 18 is produced completely from a non-magnetic metal, for instance aluminum.

Alternatively, such a position sensor arrangement may also be provided in the region of said positive-locking elements 4, 6 or on the shaft.

In this instance, in addition to said signal transmitter, an electronic sensor system for the position sensor arrangement and a motor electronic unit for controlling the electric drive EA is integrated into the circuit board 20.

The proposed locking device represents a compact, installation-space-saving and cost-effective solution within a drive train, in particular of a vehicle in the sense of a parking lock or a locking actuator, according to which the locking mechanism is integrated into the electric motor EM and the locking device is integrated into the electric motor housing EM-G.

In a vehicle with such a locking device, this means that the vehicle can be locked or blocked, for instance in response to a driver's request, in a parking situation in which the vehicle is stationary.

If, in this parking situation, the orientation of the shaft W is not such that it enables locking by the positive-locking element 4, it is possible for the positive-locking element 4, in a state in which it bears at the end face on the shaft-side complement or positive-locking element 6 or on the outer tooth arrangement AV, to be preloaded or braced, via said screw drive—formed by the spindle S and the spindle nut SM—and said helical springs 18, longitudinally with respect to the shaft W and with a definable force with respect to the shaft W for engagement. If the shaft W is subsequently turned or rotated only slightly further, the positive-locking element 4 engages with the positive-locking element 6 and consequently with the shaft 6 as soon as a corresponding orientation of the shaft W which enables the engagement is reached. Such a further turning/rotation of the shaft W in the parking situation may in this instance be brought about by the vehicle system.

However, said movement play between the two positive-locking elements 4, 6 and in the circumferential direction of the shaft W also enables the following emergency scenario in the event of a malfunction of the vehicle in which the electric motor EM of the electric motor drive unit EM-AE fails.

If there is a failure of the electric motor EM while driving and if the vehicle is subsequently braked to a standstill on a road with a gradient, the proposed locking device SV then enables locking or blockage of the vehicle which subsequently starts rolling from the stationary state, more specifically up to a maximum rotation speed of the shaft W in accordance with the movement play or the maximum speed of the vehicle.

In this instance, the positive-locking element 4 is brought into engagement with the positive-locking element 6 and consequently with the shaft W using the movement play and up to the maximum rotation speed of the shaft W in accordance with the movement play or the maximum speed of the vehicle and the vehicle is consequently brought to a standstill.

By virtue of the fact that, in a state bearing at the end face on the positive-locking element 6 or on the outer tooth arrangement AV, the positive-locking element 4 is preloaded or braced with a definable force with respect to the shaft W, via the screw drive and the helical springs 18 and longitudinally with respect to the shaft W, until engagement occurs, engagement finally takes place as soon as the shaft W undergoes a corresponding alignment with the positive-locking element 4.

Although exemplary embodiments are explained in the preceding description, it should be pointed out that a large number of modifications is possible. It should be noted, furthermore, that the exemplary embodiments are merely examples which are in no way intended to limit the scope of protection, the applications, and the structure. Instead, the above description gives a person skilled in the art a guideline for the implementation of at least one exemplary embodiment, it being possible to make various changes, especially with regard to the function and arrangement of the component parts described, without departing from the scope of protection as emerges from the claims and combinations of features that are equivalent thereto.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-6. (canceled)

7. A multifunctional shaft adapter for a locking device provided for fitting to an electric motor drive unit,
wherein the shaft adapter is configured to connect to a lockable shaft of the electric motor drive unit and is substantially produced from a plastics material;
contacts are embedded in the shaft adapter and configured for external excitation of a rotor of a synchronous machine of the electric motor drive unit,
wherein the rotor is connected to the lockable shaft, and
wherein the rotor is materially connected to a positive-locking element for connection to the lockable shaft.

8. The multifunctional shaft adapter as claimed in claim 7, wherein the contacts comprise:
at least two slip rings configured to contact an associated brush; and
at least one conductor track associated with a respective slip ring and which extends from the associated slip ring through the plastics material of the shaft adapter.

9. The multifunctional shaft adapter as claimed in claim 7, further comprising:
a sensor component of metallic design, at least in some portion or portions, fixed relative to a housing of the locking device, and configured to interact with a signal transmitter to detect a position of the rotor of the synchronous machine, received in a fixed location by the shaft adapter.

10. A locking device for an electric motor drive unit, comprising:
a housing;
a locking mechanism that locks a lockable shaft of the electric motor drive unit received by the housing;
an electric drive that actuates the locking mechanism received by the housing;
a multifunctional shaft adapter for the locking device provided for fitting to the electric motor drive unit received by the housing,
wherein the shaft adapter is configured to connect to a lockable shaft of the electric motor drive unit and is substantially produced from a plastics material;
contacts embedded in the shaft adapter and configured for external excitation of a rotor of a synchronous machine of the electric motor drive unit,
wherein the rotor is connected to the lockable shaft, and
wherein the rotor is materially connected to a positive-locking element for connection to the lockable shaft; and
a positive-locking element and a further positive-locking element of the locking mechanism actuatable in an axial stroke movement and longitudinally with respect to the shaft to lock the lockable shaft.

11. An electric motor drive unit, for driving a vehicle comprising:
an electric motor of the electric motor drive unit:
a housing of the electric motor
a locking device, which is fitted to the housing, comprising:
a locking device housing;
a locking mechanism that locks a lockable shaft of the electric motor drive unit received by the locking device housing;
an electric drive that actuates the locking mechanism received by the locking device housing,
a multifunctional shaft adapter for the locking device provided for fitting to the electric motor drive unit received by the locking device housing,
wherein the shaft adapter is configured to connect to a lockable shaft of the electric motor drive unit and is substantially produced from a plastics material;
contacts embedded in the shaft adapter and configured for external excitation of a rotor of a synchronous machine of the electric motor drive unit,
wherein the rotor is connected to the lockable shaft, and
wherein the rotor is materially connected to a positive-locking element for connection to the lockable shaft;
a positive-locking element and a further positive-locking element of the locking mechanism actuatable in an axial stroke movement and longitudinally with respect to the shaft to lock the lockable shaft.

12. A vehicle having an electric motor drive unit as claimed in claim 11.
